(19) United States
(12) Patent Application Publication
(10) Pub. No.: US 2003/0198047 A1
(43) Pub. Date: Oct. 23, 2003

(54) Patterned frame of a lighting string

(76) Inventor: Ching-Huai Chen, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/127,457

(22) Filed: Apr. 23, 2002

(51) Int. Cl. F21V 21/00

(52) U.S. Cl. 362/249

(57) ABSTRACT

The present invention relates to a patterned frame of a lighting string, which includes several similar patterned frames with different dimensions. Each of the patterned frames can be independently use for connecting with the bulb of the lighting string as a decoration. Every patterned frame can be assembled as a single patterned frame for providing a various decorative display.

### BACKGROUND OF THE INVENTION

In order to increase decorative effect of a lighting string, a patterned frame is provided for connecting with the lighting string with a specific drawing or letter. Such known patterned frame has a unit form and is somehow monotonous. There is possibility to improve the decorative effect of the lighting string.

Accordingly, the primary object of the invention is to provide a patterned frame having several units with different dimension for connecting with the lighting string with various displays that obtains better improvement and utility. Now the features and advantages of the present invention will be described in detail with reference to the accompanying drawings.

### BRIEF DESCRIPTION OF ACCOMPANYING DRAWINGS

FIG. 1 is an exploded perspective view showing a patterned frame of a lighting string according to the present invention.

FIG. 2 is an assembled perspective view of FIG. 1.

### DETAILED DESCRIPTION OF PREFERRED EMBODIMENTS

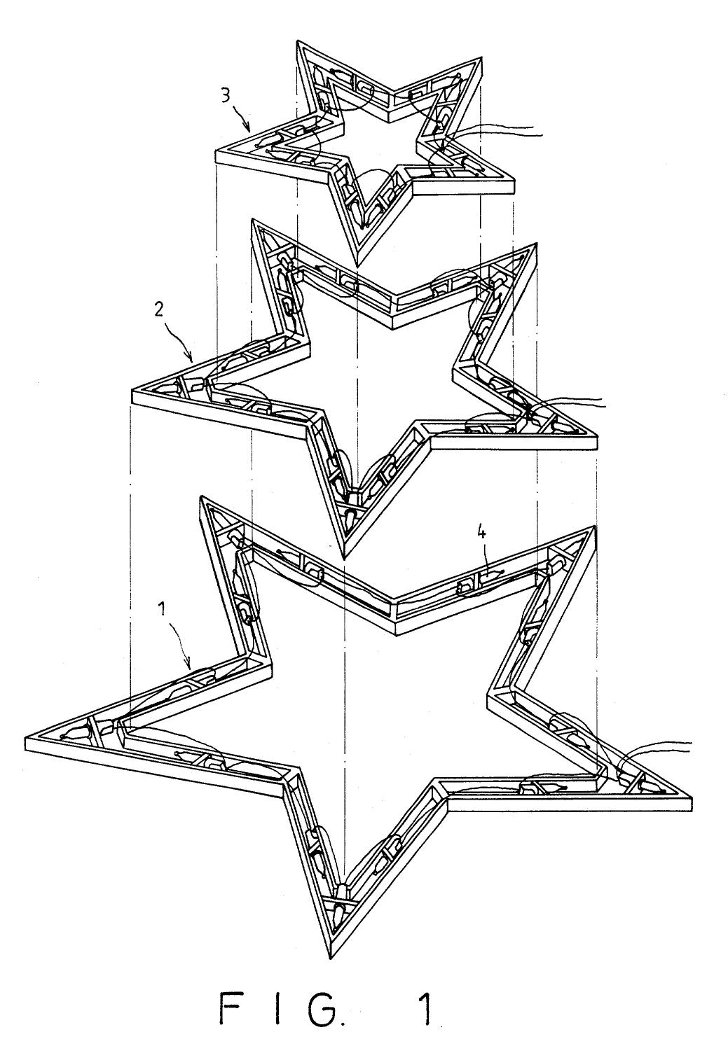

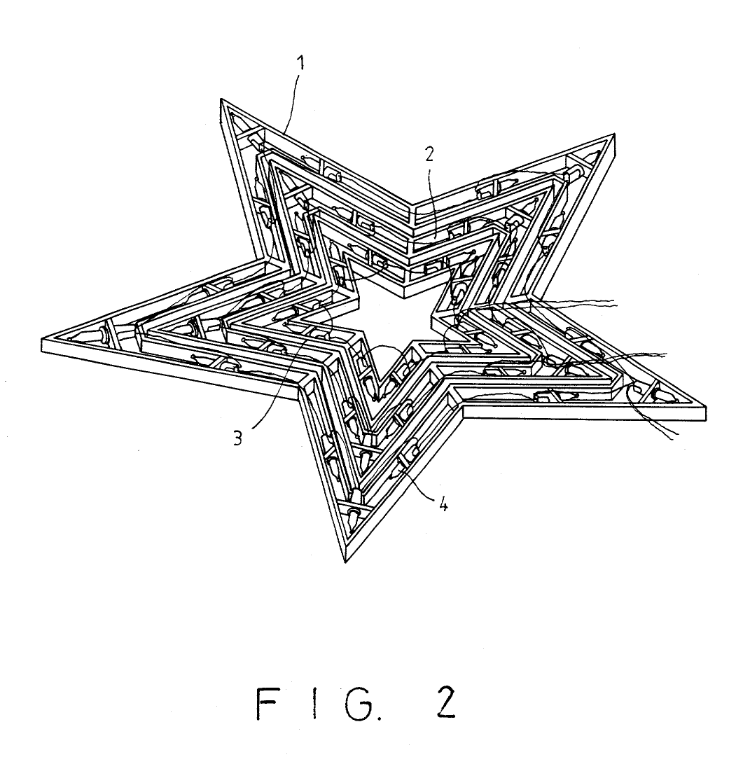

Please refer to FIGS. 1 and 2, the present invention relates to a patterned frame of a lighting string, which can be designed as any suitable figure, such as circular, polygonal, heart-typed, and so on, wherein a star-shape frame is disclosed in the invention. Furthermore, there can be two or more similar frames with different dimensions according to this invention, and there are three frames illustrated for example in this embodiment. Thus, it includes a large patterned frame (1), a middle patterned frame (2), and a small patterned frame (3). Each frame can be connected with bulbs (4) of the lighting string for independent use. Further, due to each patterned frame has different dimension and similar shape, the small frame (3) can just engaged within the middle frame (2), while the middle frame (2) is engaged within the large patterned frame (1). An assembled patterned frame including three patterned frames (1), (2), (3) becomes a single decorative structure that provides a various displaying effect with increasing utilization.

Accordingly, a characteristic of the present invention is to provide a decorative structure, which can be assembled by several similar patterned frames and can be formed with various shapes. It obtains a perfect decorative effect, which will be better than ever.

Above all, the invented assembly of the present invention obviously obtains utility and improvement. It should be allowed for patent and is applied.

What is claimed is:

1. A patterned frame of a lighting string including several similar patterned frame with different dimensions, each of which can be used independently, and a smaller patterned frame can be engaged within a larger patterned frame to become a single assembled decorative frame.

2. The patterned frame of a lighting string as claimed in claim 1, wherein the patterned frame can be designed as any suitable figure for use.

3. The patterned frame of a lighting string as claimed in claim 1, wherein the number of the patterned frame can be two or more that two.
